(19) United States
(12) Patent Application Publication
(10) Pub. No.: US 2013/0282926 A1
(43) Pub. Date: Oct. 24, 2013

(54) DATA TRANSFERRING APPARATUS AND METHOD FOR INTER-INTEGRATED CIRCUIT INTERFACE

(71) Applicant: BEYOND INNOVATION TECHNOLOGY CO., LTD., Taipei City (TW)

(72) Inventor: Bor-Yuh Chang, Taipei City (TW)

(73) Assignee: BEYOND INNOVATION TECHNOLOGY CO., LTD., Taipei City (TW)

(21) Appl. No.: 13/745,871

(22) Filed: Jan. 21, 2013

(30) Foreign Application Priority Data
Apr. 20, 2012 (TW) 101114200

(51) Int. Cl. G06F 13/38

(52) U.S. Cl. CPC G06F 13/385
USPC 710/4

(57) ABSTRACT

A data transferring apparatus and method for an inter-integrated circuit interface are disclosed. The steps of the data transferring method include: dividing a sub-address into a plurality of part sub-address byte sets; setting a plurality of sub-address addressing identification codes corresponding to the part sub-address byte sets; and transferring each of the sub-address addressing identification codes and each of the corresponding part sub-address byte sets in sequence within each of a plurality of time periods for a sub-address addressing operation of the sub-address.

### CROSS-REFERENCE TO RELATED APPLICATION

This application claims the priority benefit of Taiwan application serial no. 101114200, filed on Apr. 20, 2012. The entirety of the above-mentioned patent application is hereby incorporated by reference herein and made a part of this specification.

### BACKGROUND OF THE INVENTION

1. Field of the Invention

The invention relates to a data transferring method for an inter-integrated circuit interface. More particularly, the invention relates to an expansion method for a sub-address of an inter-integrated circuit interface.

2. Description of Related Art

With the advance of the semiconductor fabricating techniques, contemporary electronic devices can be steadily operated in coordination with clock signals in high frequency. Relatively, a so-called serial data transferring interface gradually becomes a trend to be used for effectively minimizing layout areas of data transferring wires among electronic devices in data transferring operations among electronic devices.

An example is taken as a data transferring method for an inter-integrated circuit (I²C) interface. Referring to FIG. 1, which is a schematic diagram illustrating a signal on a data line SDA of a conventional inter-integrated circuit interface, wherein a first data bit that a master terminal transfers through a data line SDA of the inter-integrated circuit interface is a start bit ST and after the start bit ST, the master terminal then transfers device addressing set DA having 7 bits and a read/write identification bit RW, wherein the device addressing set DA is adopted for transferring a module address (MAD). In addition, the master terminal delivers a sub-address set SADL, a data set DT and a stop bit SP on the data line SDA, and a slave terminal responds and transfers an acknowledgement bit ACK to the master terminal through the data line SDA between the read/write identification bit RW and a sub-address set SADL, between a sub-address set SADL and a data set DT as well as between the data set DT and the stop bit SP.

In the illustration of FIG. 1, when bit numbers of sub-addresses being transferred by the master terminal is bigger than 8 bits, the sub-address set SADL is not capable of transferring all sub-addresses. In the conventional technical field, a plurality of bits SADM of the device addressing set DA is selectively occupied to transfer a plurality of high bits (MSB) P2˜P0 of sub-addresses and transfer the rest of a plurality of low bits (LSB) of sub-addresses through the sub-address set SADL. Accordingly, even though bit numbers of sub-address being transferred by the master terminal is effectively expanded, the module address being transferred by the master terminal is restrained.

Furthermore, in the illustration of FIG. 1, when repeating addressing is performed to a sub-address in a slave terminal, the master terminal has to re-transfer data of the device addressing set DA, the read/write identification bit RW and the sub-address set SADL, totaled 16 bits, wherein bits other than bits SADM in the device address set DA being transferred are unnecessary data transfer, and therefore, the data transferring efficiency is decreased.

### SUMMARY OF THE INVENTION

The invention provides a data transferring method for an inter-integrated circuit interface that can expand numbers of bits of sub-address (SAD) based on the needs.

The invention provides a data transferring interface apparatus for an inter-integrated circuit that can expand numbers of bits of sub-address (SAD) based on the needs.

The invention provides a data transferring method for an inter-integrated circuit interface, wherein the steps include: dividing a sub-address into a plurality of part sub-address byte sets; setting a plurality of sub-address addressing identification codes corresponding to the part sub-address byte sets; and sequentially transferring each of the sub-address addressing identification codes and each of the corresponding part sub-address byte sets within each of a plurality of time periods for performing a sub-address addressing operation of the sub-address.

An embodiment of the invention further includes transferring a write-in data or receiving a read data by the inter-integrated circuit interface after the addressing operation of the sub-address is completed.

In one embodiment of the invention, each of the part sub-address byte sets has 8 bits.

In an embodiment of the invention, during each of the time periods, the step of transferring a read/write identification bit is further included between transferring each of the sub-address addressing identification codes and each of the corresponding part sub-address byte sets.

In an embodiment of the invention, during each of the time periods, the step of receiving an acknowledgement bit is further included between transferring each of the sub-address addressing identification codes and each of the corresponding part sub-address byte sets, and after transferring a read/write identification bit.

An embodiment of the invention further includes transferring a start bit when each of the time periods starts.

An embodiment of the invention further includes transferring a stop bit after each of the time periods stops.

The invention provides a data transferring interface apparatus for an inter-integrated circuit, which is configured to transfer data between a master device and a slave device. The data transferring interface apparatus includes a data transferring line set, a master terminal transceiving controller and a slave terminal transceiving controller. The master terminal transceiving controller is coupled to the master device and also coupled to the slave device through the data transferring line set. The master terminal transceiving controller divides a sub-address into a plurality of part sub-address byte sets, sets a plurality of sub-address addressing identification codes corresponding to the part sub-address byte sets, and sequentially transferring each of the sub-address addressing identification codes and each of the corresponding part sub-address byte sets respectively within each of a plurality of time periods for an addressing operation of a sub-address in the slave device. The slave terminal transceiving controller is coupled to the slave device and also coupled to the master terminal transceiving controller through the data transferring line set for receiving a data transferred by the master terminal transceiving controller.

In light of the above, in the invention, various part sub-address byte sets in sub-addresses are transferred in a way of transferring sub-address addressing identification codes. Accordingly, in a state of a module address occupying minimum fields, bit numbers of sub-addresses can be effectively expanded and the data transferring efficiency of the inter-integrated circuit interface can be effectively enhanced.

In order to make the aforementioned features and advantages of the invention more comprehensible, embodiments accompanied with figures are described in details below.

### BRIEF DESCRIPTION OF THE DRAWINGS

FIG. 1 is a schematic diagram illustrating a signal on a data line SDA of a conventional inter-integrated circuit interface.

FIG. 2 is a schematic diagram illustrating a data transferring interface apparatus 200 of an inter-integrated circuit according to an embodiment of the invention.

FIG. 3 is a flow chart illustrating a data transferring method of an inter-integrated circuit interface according to an embodiment of the invention.

FIG. 4A and FIG. 4B are schematic diagrams illustrating a signal transferred by a data line SDA according to an embodiment of the invention.

FIG. 5A is a schematic diagram illustrating a write data of an inter-integrated circuit interface according to an embodiment of the invention.

FIG. 5B illustrates another description of an implementation regarding a write data of an inter-integrated circuit interface according to the embodiment of the invention.

FIG. 5C is a schematic diagram illustrating a read data of an inter-integrated circuit interface according to an embodiment of the invention.

FIG. 5D illustrates another description of an implementation regarding a read data of an inter-integrated circuit interface according to the embodiment of the invention.

FIG. 5E illustrates yet another description of an implementation regarding a read data of an inter-integrated circuit interface according to the embodiment of the invention.

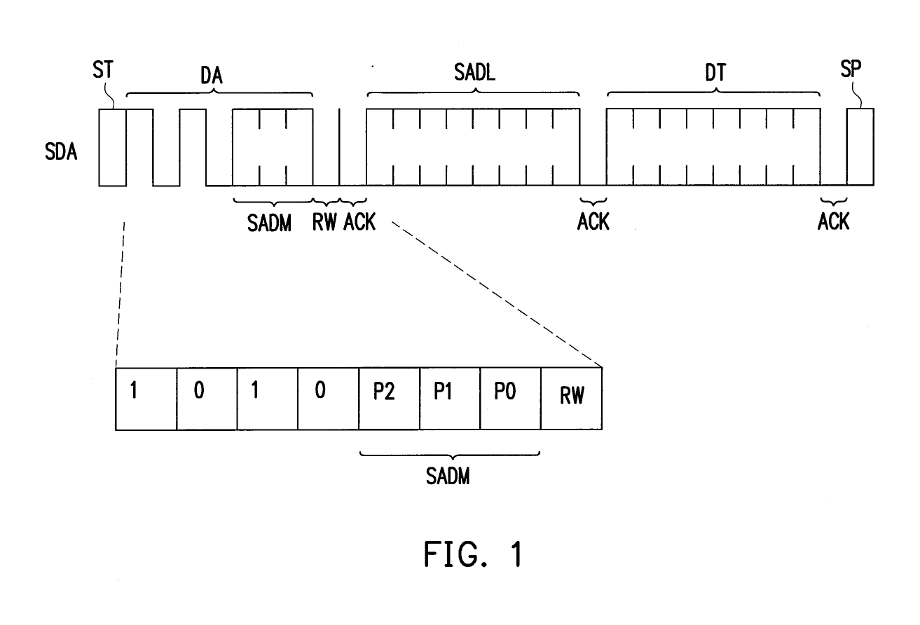

### DESCRIPTION OF EMBODIMENTS

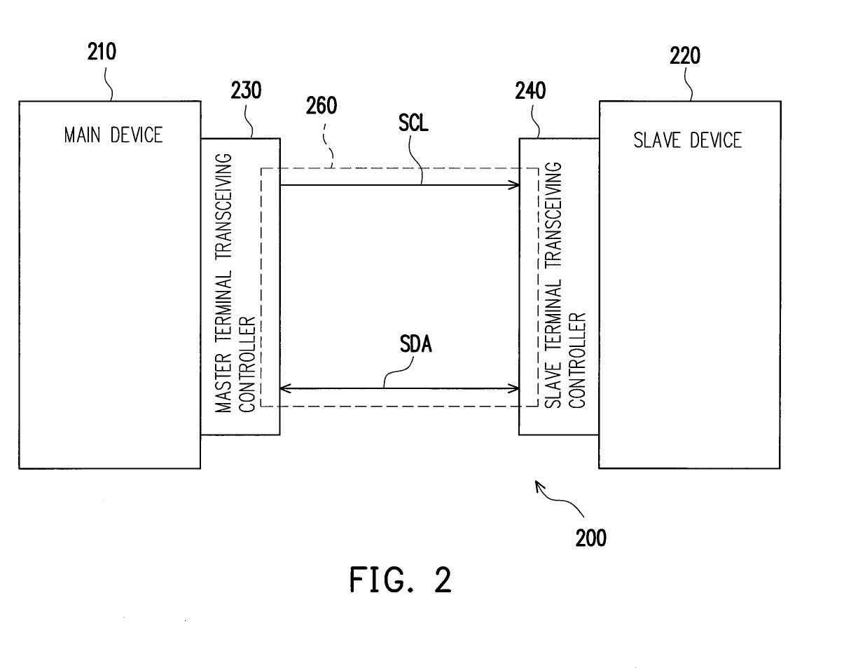

Referring to FIG. 2. FIG. 2 is a schematic diagram illustrating a data transferring interface apparatus 200 of an inter-integrated circuit according to an embodiment of the invention. The data transferring interface apparatus 200 is disposed between a master device 210 and a slave device 220 and is configured to transfer data between the master device 210 and the slave device 220. The data transferring interface apparatus 200 includes a master terminal transceiving controller 230, a slave terminal transceiving controller 240 and a data transferring line set 260, wherein the master terminal transceiving controller 230 is coupled to the master device 210 and performs a data transferring operation with the slave terminal transceiving controller 240 through the data transferring line set 260. In addition, the slave terminal transceiving controller 240 is coupled to the slave device 220.

It should also be mentioned that the data transferring line set 260 is consisted of a data line SDA and a clock line SCL. The data transferring line set 260 performs a transferring operation of a data through a signal transferred through the data line SDA in collocation with a transition point of a clock signal transferred by the clock line SCL.

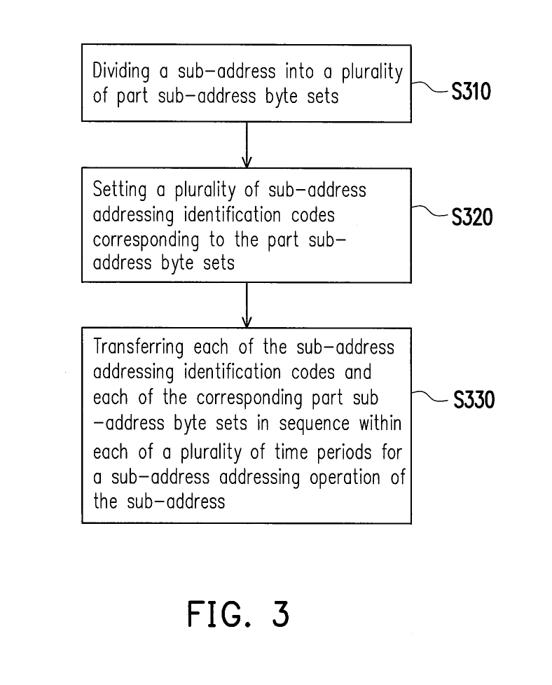

Referring to FIG. 2 and FIG. 3 together regarding data transferring details of the data transferring interface apparatus 200, wherein FIG. 3 is a flow chart illustrating a data transferring method of an inter-integrated circuit interface according to an embodiment of the invention. In FIG. 3, when the master device 210 performs a data write-in operation to the slave device 220, in Step S310, the master terminal transceiving controller 230 divides a sub-address addressing the slave device 220 into a plurality of part sub-address byte sets. Take a 16-bit sub-address as an example. Specifically, the master terminal transceiving controller 230 divides the 16-bit sub-address into two 8-bit part sub-address byte sets based on a method of high and low effective sets of the sub-address. Of course, if a sub-address comprises 24 bits, the master terminal transceiving controller 230 divides the 24-bit sub-address into three 8-bit part sub-address byte sets.

Additionally, in Step S320, the master terminal transceiving controller 230 sets a plurality of sub-address addressing identification codes corresponding to the part sub-address byte sets. Continuing the example of the 16-bit sub-address, the master terminal transceiving controller 230 may set a sub-address addressing identification code based on a part sub-address byte set acquired by dividing a sub-address comprising the highest 8 bits. The master terminal transceiving controller 230 may set another sub-address addressing identification code based on a part sub-address byte set acquired by dividing a sub-address comprising the lowest 8 bits. Herein, a sub-address addressing identification code is used to inform the slave device 220 whether a received part sub-address byte set is a sub-address comprising high sets or low sets.

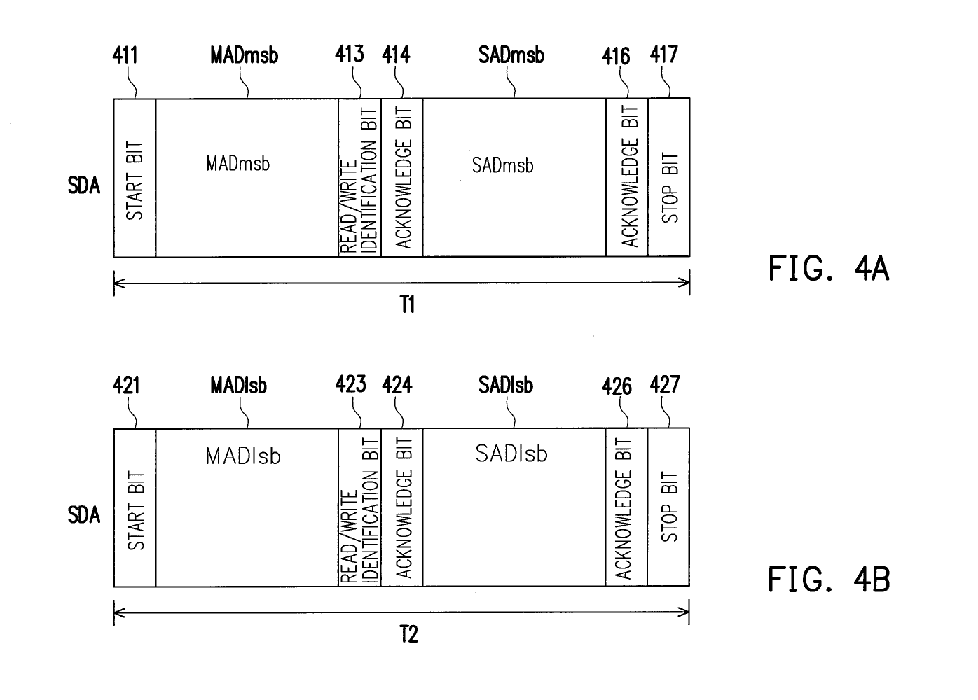

Next, in Step S330, the master terminal transceiving controller 230 sequentially transfers each of the sub-address addressing identification codes and each of the corresponding part sub-address byte sets within each of a plurality of time periods for an addressing operation of the sub-address to the slave device 220. Referring to FIGS. 3, 4A and 4B together for detailed operations in Step S330. FIGS. 4A and 4B are schematic diagrams illustrating a signal transferred by a data line SDA according to an embodiment of the invention.

In FIG. 4A, the master terminal transceiving controller 230 transfers a sub-address addressing identification code MADmsb and a part sub-address byte set SADmsb of the corresponding sub-address addressing identification code MADmsb through the data line SDA during the first time period T1, wherein the sub-address addressing identification code MADmsb may instruct the master terminal transceiving controller 230 that the part sub-address byte set SADmsb being transferred during the first time period T1 as high sets of a sub-address.

Next, in FIG. 4B, the master terminal transceiving controller 230 transfers a sub-address addressing identification code MADlsb and a part sub-address byte set SADlsb of the corresponding sub-address addressing identification code MADlsb during the second time period T2, wherein the sub-address addressing identification code MADlsb may instruct the master terminal transceiving controller 230 that the part sub-address byte set SADlsb which is transferred during a second time period T2 as low sets of a sub-address.

In light of the above description, after the second time period T2, the slave terminal transceiving controller 240 may acquired a complete sub-address by the received sub-address addressing identification code MADmsb and the corresponding part sub-address byte set SADmsb as well as the sub-address addressing identification code MADlsb and the corresponding part sub-address byte set SADlsb. In other words, an address operation of a sub-address performed to the slave device 220 may be easily accomplished.

It should also be mentioned that, when the first time period T1 starts, the master terminal transceiving controller 230 transfers a start bit 411 through the data line SDA and transfers a read/write identification bit 413 after transferring the sub-address addressing identification code MADmsb, and transfers a stop bit 417 before the first time period T1 stops. The slave terminal transceiving controller 240 then transfers two acknowledge bits 414 and 416 to the master terminal transceiving controller 230 through the data line SDA after receiving the sub-address addressing identification code MADmsb and the part sub-address byte set SADmsb to notify the master terminal transceiving controller 230 that the sub-address addressing identification code MADmsb and the part sub-address byte set SADmsb are successfully transferred to the slave terminal transceiving controller 240.

Relatively, when the second time period T2 starts, the master terminal transceiving controller 230 transfers a start bit 421 through the data line SDA and transfers a read/write identification bit 423 after transferring the sub-address addressing identification code MADlsb, and transfers a stop bit 427 before the second time period T2 stops. The slave terminal transceiving controller 240 then transfers acknowledge bits 424 and 426 to the master terminal transceiving controller 230 through the data line SDA after receiving the sub-address addressing identification code MADlsb and the part sub-address byte set SADlsb to notify the master terminal transceiving controller 230 that the sub-address addressing identification code MADlsb and the part sub-address byte set SADlsb are successfully transferred to the slave terminal transceiving controller 240.

In light of the above description, when a bit Nb of a sub-address needs to be expanded, what is needed is to set enough sub-address addressing identification codes and to set corresponding part sub-address byte sets SADmsb and making them as a N pair, that is, from a part sub-address byte set SADmsb1 to a part sub-address byte set SADmsbn, more addressing operations of the sub-addresses to the slave device 220 can be performed effectively.

It should be noted that, when the master terminal transceiving controller 230 performs an addressing operation of a module address to the slave device 220, the master terminal transceiving controller 230 only needs to transfer a address data that is not a sub-address addressing identification code after a start bit, in a state that the slave terminal transceiving controller 240 receives and determines that a received address data is not a sub-address addressing identification code, the master terminal transceiving controller 230 recognizes the received address data as a module address, and the slave device 220 performs an addressing operation of the module address.

A plurality of practical examples are stated below to further describe in details the method of data transferring of the inter-integrated circuit interface according to embodiments of the invention for better comprehension and implementations by people of ordinary skill in the art.

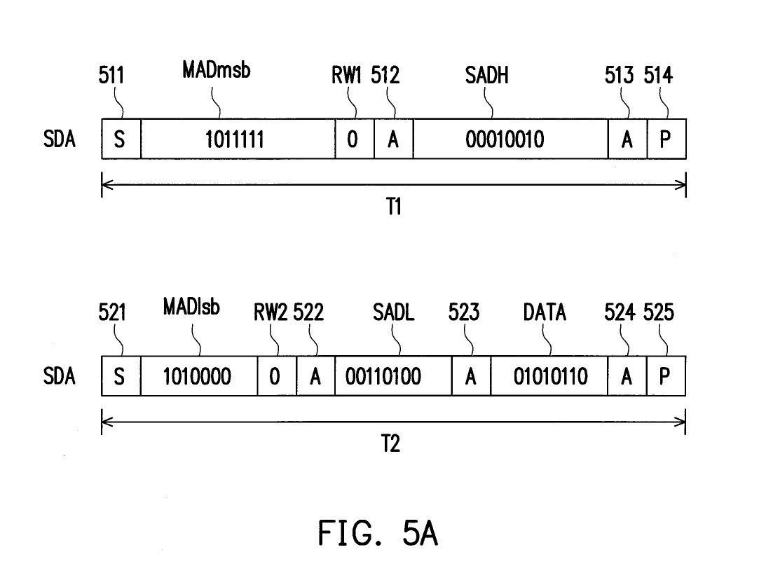

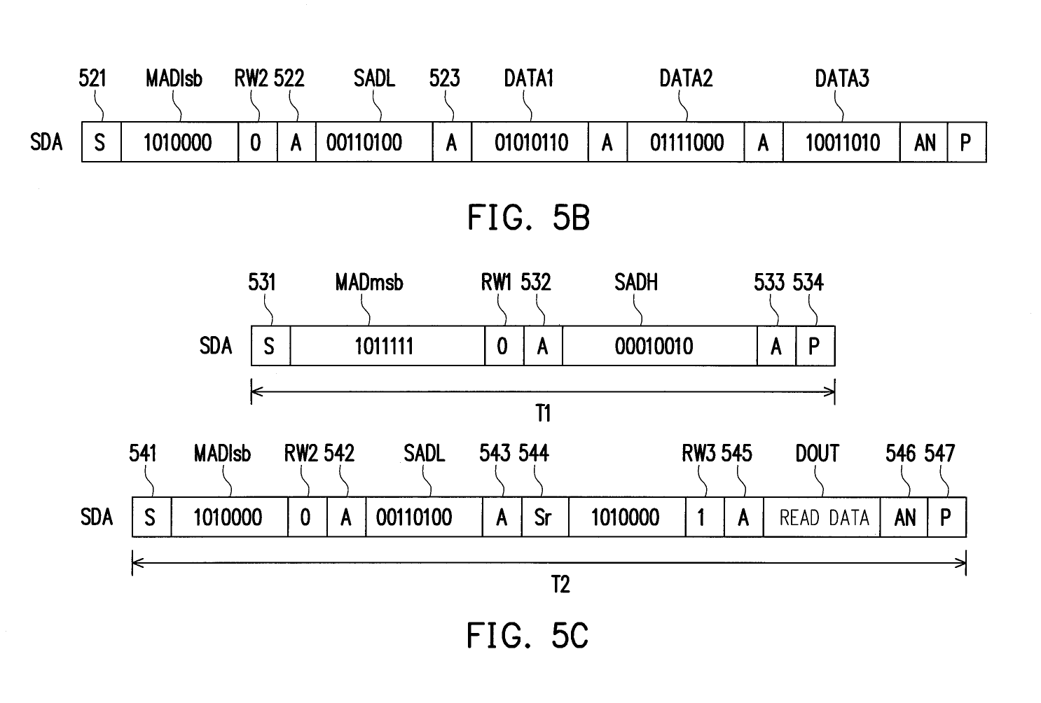

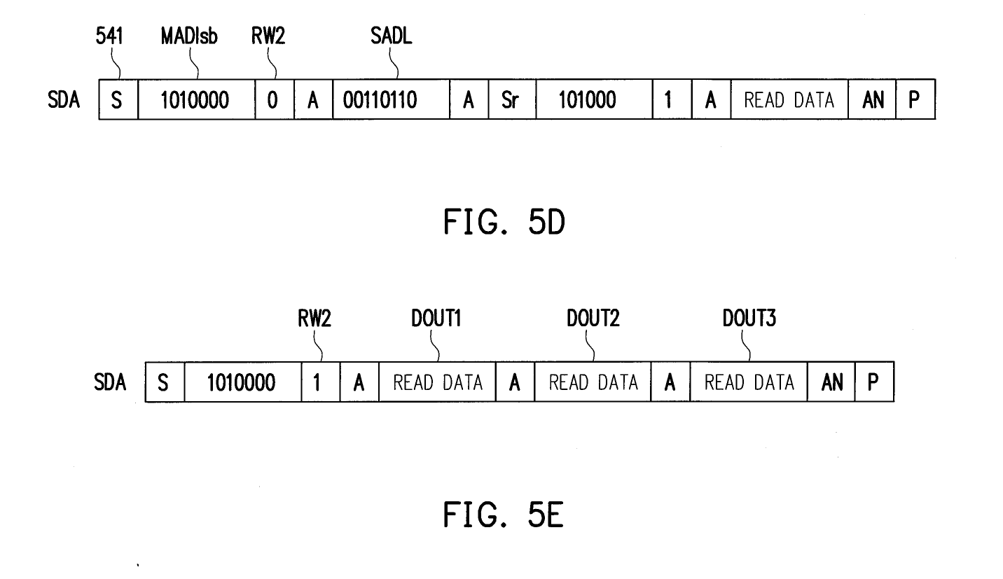

Referring to FIG. 5A. FIG. 5A is a schematic diagram illustrating a write data of an inter-integrated circuit interface according to an embodiment of the invention. wherein, in an illustration of FIG. 5A, a sub-address addressing identification code corresponding to a part sub-address byte set of a sub-address having high sets is set as a binary code “1011111”, and a sub-address addressing identification code corresponding to a part sub-address byte set of a sub-address having low sets is set as a binary code “1010000”. An example is illustrated as the master device writes a data (equivalent to 0x56 in hexadecimal code) to a sub-address of 0x1234 in hexadecimal code in the slave device. During the time period T1, after a start bit 511, the master terminal transceiving controller 230 transfers a sub-address addressing identification code MADmsb in binary code “1011111” and a read/write bit RW1 equivalent to “0” through the data line SDA to represent a write-in operation of a sub-address having high sets. Next, after the slave device responds to an acknowledgement bit 512, the master device transfers a part sub-address byte set SADH in binary code “00010010” (0x12 in hexadecimal code), which is also a sub-address having high sets (equivalent to 0x1234).

In addition, the slave device corresponds and responds to an acknowledgement bit 513 after receiving a part sub-address byte set, and the master device then corresponds and transfers a stop bit 514 after the acknowledgement bit 513 is responded.

Next, during the time period T2, after a start bit 521, the master terminal transceiving controller 230 transfers the sub-address addressing identification code MADlsb in binary code “1010000” and the read/write bit RW2 equivalent to “0” for performing a write-in operation of a sub-address having low sets. Next, after the slave device responds to an acknowledgement bit 522, the master device transfers a part sub-address byte set SADL in binary code “00110100” (0x34 in hexadecimal code), which is also a sub-address having low sets (equivalent to 0x1234). In the meantime, since the sub-address having high and low sets are written in the slave device without a hitch, the master terminal transceiving controller 230 transfers and writes a data DATA (equivalent to 0x56 in hexadecimal code) to the slave device after responding to an acknowledgement bit 523 through the data line SDA.

Lastly, the slave device responds to an acknowledgement 524 and confirms that a data write-in operation is completed, and the master terminal transceiving controller 230 responds and transfers a stop bit 525.

In addition, referring to FIG. 5B. FIG. 5B illustrates another description of an implementation regarding a write-in data of an inter-integrated circuit interface according to an embodiment of the invention. In the implementation, the inter-integrated circuit interface may also perform a data write-in operation in burst mode. In other words, the inter-integrated circuit interface of the embodiment of the invention may sequentially write data to sequential addresses of the slave device by sequentially transferring write-in data. Take FIG. 5B as an example, after the data line SDA completes a transfer of the part sub-address byte set SADL (0x34 in hexadecimal code), the data line SDA may sequentially transfers data DATA1˜DATA3 (0x56, 0x78 and 0x9A respectively in hexadecimal code) to the slave device, and writes 0x56, 0x78 and 0x9A respectively to a storage field where sub-addresses are equivalent to 0x1234, 0x1235 and 0x1236 in the slave device, wherein a number of the sub-addresses of the slave device increase by “1” for each time the write-in is written.

Referring to FIG. 5C. FIG. 5C is a schematic diagram illustrating a read data of an inter-integrated circuit interface according to an embodiment of the invention, wherein a sub-address addressing identification code corresponding to a part sub-address byte set of a sub-address having high sets is set as a binary code “1011111,” and a sub-address addressing identification code corresponding to a part sub-address byte set of a sub-address having low sets is set as a binary code “1010000”. Also, an example is taken as the master device reads data of a sub-address (equivalent to 0x1234 in hexadecimal code) of the slave device. First, during the time period T1, after a start bit 531, the master terminal transceiving controller 230 transfers the sub-address addressing identification code MADmsb in binary code “1011111” and the read/write bit RW1 equivalent to “0” through the data line SDA to represent a write-in operation of a sub-address having high sets. Next, after the slave device responds to and confirms an acknowledgement bit 532, the master device transfers a part sub-address SADH in binary code “00010010” (0x12 in hexadecimal code), which is also a sub-address having high sets (equivalent to 0x1234).

In addition, the slave device corresponds and responds to an acknowledgement bit 533 after receiving the part sub-address byte set, and the master device then corresponds and transfers a stop bit 534 after the stop bit 533 is responded.

Next, during the time period T2, after a start bit 541, the master terminal transceiving controller 230 transfers the sub-address addressing identification code MADlsb in binary code “1010000” and the read/write bit RW2 equivalent to “0” through the data line SDA for performing a write-in operation to a sub-address having low sets. Next, after the slave device responds to an acknowledgement bit 542, the master device transfers the part sub-address byte set SADL in binary code “00110100” (0x34 in hexadecimal code), which is also a sub-address having low sets (equivalent to 0x1234).

After a write-in operation of a sub-address in the slave device is completed and after the slave device responds and transfers an acknowledgement bit 543, the master terminal transceiving controller 230 sequentially transfers a repeat start bit 544, a binary code “1010000” (equivalent to the sub-address addressing identification code MADlsb) and a read/write bit RW3 equivalent to “1” for performing a read operation to the sub-address 0x1234 of the slave device. The slave device responds to an acknowledgement bit 545 first and then transfers a read data DOUT, and after a field 546 of an unacknowledgement signal, the master terminal transceiving controller 230 transfers a stop bit 547.

It should be noted that, from the aforementioned implementation, when the master device performs multiple operations of data write-ins or data reads to the slave device, in a state that high (or low) sets of sub-addresses are not changed, operations of repeated write-ins are not required in corresponding to a part sub-address byte set of high (or low) sets of a sub-address. In this way, the efficiency of data transfer can be effectively increased.

Relatively, in terms of performing changes especially to high (or low) sets of the slave device, please referring to FIG. 5D illustrates another description of an implementation regarding a read data of an inter-integrated circuit interface according to the embodiment of the invention. In FIG. 5D, an example is taken as changed low sets of the slave device have performed data reading, the master terminal transceiving controller 230 transfers the sub-address addressing identification code MADlsb in binary code “1010000” and the read/write bit RW2 equivalent to “0” for performing a write-in operation to a sub-address having low sets. Afterward, the master terminal transceiving controller 230 transfers the part sub-address byte set SADL in binary code “00110110” (0x36 in hexadecimal code) through the data line SDA, such that a sub-address addressing of the slave device is changed from 0x1234 to 0x1236, and after completing the change of the sub-address addressing, the master device can read new data of the sub-address of the slave device.

Referring to FIG. 5E which illustrates yet another description of an implementation regarding a data reading of an inter-integrated circuit interface according to the embodiment of the invention. In the implementation of the invention, the inter-integrated circuit interface may also perform a data reading operation in burst mode. In FIG. 5E, after completing addressing a sub-address of the slave device (i.e. the addressing is 0x1234) and by setting the read/write bit RW2 equivalent to “1”, the slave device can sequentially transfer multiple read data DOUT1, DOUT2 and DOUT3 through the data line SDA, and the read data DOUT1, DOUT2 and COURT3 are stored respectively in storage fields of the sub-addresses 0x1234, 0x1235 and 0x1236 of the slave device.

In summary, a sub-address addressing identification code is used in the invention to independently perform addressing operations of module addresses and sub-addresses. In other words, limitations to the module address are greatly reduced when sub-addresses expand, and expansion levels of sub-addresses can be even bigger and more flexible. Additionally, since each of part sub-address byte sets of a sub-address can be addressed respectively and independently, data transferring efficiency can be increased when performing multiple operations of data write-ins or data readings.

Although the invention has been disclosed by the above embodiments, they are not intended to limit the invention. It will be apparent to people of ordinary skill in the art that modifications and variations to the invention may be made without departing from the spirit and the scope of the invention. Accordingly, the protection scope of the invention falls in the appended claims.

What is claimed is:

1. A data transferring method for an inter-integrated circuit (I²C) interface, comprising:
dividing a sub-address into a plurality of part sub-address byte sets;
setting a plurality of sub-address addressing identification codes corresponding to the part sub-address byte sets; and
sequentially transferring each of the sub-address addressing identification codes and each of the corresponding part sub-address byte sets within each of a plurality of time periods for an addressing operation of the sub-address.

2. The data transferring method for the inter-integrated circuit interface as recited in claim 1, further comprising:
transferring a write data or receiving a read data by the inter-integrated circuit interface after the addressing operation of the sub-address is completed.

3. The data transferring method for the inter-integrated circuit interface as recited in claim 1, wherein each of the part sub-address byte sets has 8 bits.

4. The data transferring method for the inter-integrated circuit interface as recited in claim 1, wherein after the step of between transferring each of the sub-address addressing identification codes and each of the corresponding part sub-address byte sets within each of the plurality of time periods, further comprises transferring a read/write identification bit.

5. The data transferring method for the inter-integrated circuit interface as recited in claim 4, wherein between the step of transferring each of the sub-address addressing identification codes and each of the corresponding part sub-address byte sets and after transferring the read/write identification bit within each of the plurality of time periods, further comprises: receiving an acknowledgement bit.

6. The data transferring method for the inter-integrated circuit interface as recited in claim 1, wherein the step of starting each of the time period further comprises transferring a start bit.

7. The data transferring method for the inter-integrated circuit interface as recited in claim 1, wherein the step of stopping each of the time periods further comprises transferring a stop bit.

8. A data transferring interface apparatus for an inter-integrated circuit (I²C), configured to transfer data between a master device and a slave device, comprising:
a data transferring line set;
a master terminal transceiving controller, coupled to the master device and coupled to the slave device through the data transferring line set, wherein the master terminal transceiving controller divides a sub-address into a plurality of part sub-address byte sets and sets a plurality of sub-address addressing identification codes corresponding to the part sub-address byte sets, and the master terminal transceiving controller sequentially transfers each of the sub-address addressing identification codes and each of the corresponding part sub-address byte sets within each of a plurality of time periods for an addressing operation of the sub-address of the slave device; and
a slave terminal transceiving controller, coupled to the slave device and coupled to the master transceiving controller through the data transferring line set for receiving a data transferred from the master terminal transceiving controller.

9. The data transferring interface apparatus as recited in claim 8, wherein the master terminal transceiving controller further comprises: after the addressing operation of the sub-address of the slave device is completed, a write data is transferred through the data transferring line set to the slave device or a read data is received from the slave device through the data transferring line set.

10. The data transferring interface apparatus as recited in claim 8, wherein each of the part sub-address byte sets comprises 8 bits.

11. The data transferring interface apparatus as recited in claim 8, wherein the master transceiving controller, after transfers each of the sub-address addressing identification codes and each of the corresponding part sub-address byte sets within each of the plurality of time periods, further comprises transferring a read/write identification bit to the slave device.

12. The data transferring interface apparatus as recited in claim 11, wherein after transferring each of the sub-address addressing identification codes and each of the corresponding part sub-address byte sets within each of the plurality of time periods and after transferring the read/write identification bit, the master terminal transceiving controller further comprises receiving an acknowledgement bit transferred from the slave terminal transceiving controller.

13. The data transferring interface apparatus as recited in claim 8, wherein when each of the time period starts, the master terminal transceiving controller further comprises transferring a start bit.

14. The data transferring interface apparatus as recited in claim 8, wherein when each of the time period stops, the master terminal transceiving controller further comprises transferring a stop bit.
